(19) United States
(12) Patent Application Publication
(10) Pub. No.: US 2026/0353286 A1
(43) Pub. Date: Nov. 5, 2026

(54) NETWORK ENERGY SAVING METHOD, AND RELATED DEVICES

(71) Applicant: PURPLEVINE INNOVATION COMPANY LIMITED, Hongkong (HK)

(72) Inventor: Chiu-Wen CHEN, Hongkong (HK)

(73) Assignee: PURPLEVINE INNOVATION COMPANY LIMITED, Hongkong (HK)

(21) Appl. No.: 19/116,361

(22) PCT Filed: Sep. 28, 2023
(86) PCT No.: PCT/CN2023/122898

§ 371 Date: Mar. 27, 2025

(51) Int. Cl. H04W 52/02; H04W 76/28

(52) U.S. Cl. CPC H04W 52/0235; H04W 76/28

(57) ABSTRACT

A network energy saving (NES) method and related devices are provided. The NES method, performed by a user equipment (UE), includes determining whether a network control node is in a NES state and whether NES capability is supported by the UE; if the network control node is in the NES state and the UE supports the NES capability, upon reception of a NES barring indication transmitted by the network control node, being permitted to access the network control node in the NES state; and if the network control node is in the NES state and the UE does not support the NES capability, being barred to access the network control node in the NES state. With this method, the network control node can operate in the NES state, thereby lowering power consumption for the network.

### TECHNICAL FIELD

The present disclosure relates to the field of wireless communications, and more particularly, to a network energy saving (NES) method, and related devices.

### BACKGROUND ART

Communication systems and networks have developed towards being a broadband and mobile system. In cellular wireless communication systems developed by the Third Generation Partnership Project (3GPP), user equipment (UE) is connected by a wireless link to a radio access network (RAN). The RAN includes a set of base stations (BSs) which provide wireless links to the UEs located in cells covered by the base station, and an interface to a core network (CN) which provides overall network control. The RAN and CN each conduct respective functions in relation to the overall network. The 3GPP has developed the so-called Long-Term Evolution (LTE) system, namely, an Evolved Universal Mobile Telecommunication System Territorial Radio Access Network (E-UTRAN), for a mobile access network where one or more macro-cells are supported by a base station known as an eNodeB or eNB (evolved NodeB). More recently, evolved from LTE, the so-called 5G or New radio (NR) systems where one or more cells are supported by a base station known as a gNB.

Network energy saving is of great importance for environmental sustainability, to reduce environmental impact (greenhouse gas emissions), and for operational cost savings. As 5G is becoming pervasive across industries and geographical areas, handling more advanced services and applications requiring very high data rates (e.g., XR), networks are being denser, use more antennas, larger bandwidths and more frequency bands. The environmental impact of 5G needs to stay under control, and solutions to improve network energy savings need to be developed.

Energy consumption has become a key part of the operators' OPEX. The power consumption of a radio access can be split into two parts: the dynamic part which is only consumed when data transmission/reception is ongoing, and the static part which is consumed all the time to maintain the necessary operation of the radio access devices, even when the data transmission/reception is not on-going. Typical prior art is designed for turning on/off cell without system adaptive consideration. The cell switch-off decision is only made by the network side, which is not well performed by current specifications. Therefore, there is a need to improve network energy saving in cellular communication systems.

### SUMMARY

The disclosure can be used to achieve lower power consumption for the network.

In a first aspect of the present disclosure, provided is a network energy saving (NES) method, performed by a user equipment (UE), the method comprising: determining whether a network control node is in a NES state and whether NES capability is supported by the UE; if the network control node is in the NES state and the UE supports the NES capability, upon reception of a NES barring indication transmitted by the network control node, being permitted to access the network control node in the NES state; and if the network control node is in the NES state and the UE does not support the NES capability, being barred to access the network control node in the NES state.

In a second aspect of the present disclosure, provided is a network energy saving (NES) method, performed by a network control node, the method comprising: transmitting to a NES barring indication to a user equipment (UE) to permit the UE to access the network control node in a NES state if the UE is a NES-capable UE which supports NES capability; and baring the UE to access the network control node in the NES state if the UE is a non-NES-capable UE which does not support the NES capability.

In a third aspect of the present disclosure, a user equipment includes a memory and a processor coupled to the memory, the processor configured to call and run program instructions stored in a memory, to execute the above method.

In a fourth aspect of the present disclosure, a network control node includes a memory and a processor coupled to the memory, the processor configured to call and run program instructions stored in a memory, to execute the above method.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1a is a schematic diagram illustrating a communication controlling system according to an embodiment of the present disclosure.

FIG. 1b is a block diagram of a user equipment and a base station of wireless communication in a communication controlling system according to an embodiment of the present disclosure.

FIG. 2a is a schematic diagram illustrating user plane radio protocol architecture within gNB and UE for NR MBS.

FIG. 2b is a schematic diagram illustrating a gNB further including a centralized unit (CU) and a plurality of distributed unit (DUs).

FIG. 3 is a flowchart of a network energy saving (NES) method according to some embodiments of the present disclosure.

FIG. 4 shows an overview of gNB state transitions in NR.

FIG. 5 shows a network control node and terminal devices operated in NES state of the network control mode for TDD system according to some embodiments of the present application.

FIG. 6 shows a network control node and terminal devices operated in NES state of the network control mode for FDD system according to some embodiments of the present application.

FIG. 7a shows a network control node and terminal devices operated in NES state of the network control mode for multi-carrier operation in a first case according to some embodiments of the present application.

FIG. 7b shows a network control node and terminal devices operated in NES state of the network control mode for multi-carrier operation in a second case according to some embodiments of the present application.

FIG. 7c shows a network control node and terminal devices operated in NES state of the network control mode for multi-carrier operation in a third case according to some embodiments of the present application.

FIG. 8 shows a network control node and terminal devices operated in NES state of the network control mode for multi-connection operation according to some embodiments of the present application.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In this document, the symbol “/” should be interpreted to indicate “and/or.” A combination such as “at least one of A, B, or C,” “one or more of A, B, or C,” “at least one of A, B, and C,” “one or more of A, B, and C,” or “A, B, and/or C” may be A only, B only, C only, A and B, A and C, B and C, or A and B and C, where any combination may contain one or more members of A, B, or C.

A flexible network energy saving (NES) framework in time/frequency/power/spatial domain adaptation with UE assistance information is proposed in this disclosure. In some embodiments, for NES state alignment between the network and UEs, a common NES radio resource and NES timer may be proposed for data transmission/reception without network state transition. It can be used to reduce the energy consumption of the network while maintaining scalability and flexibility.

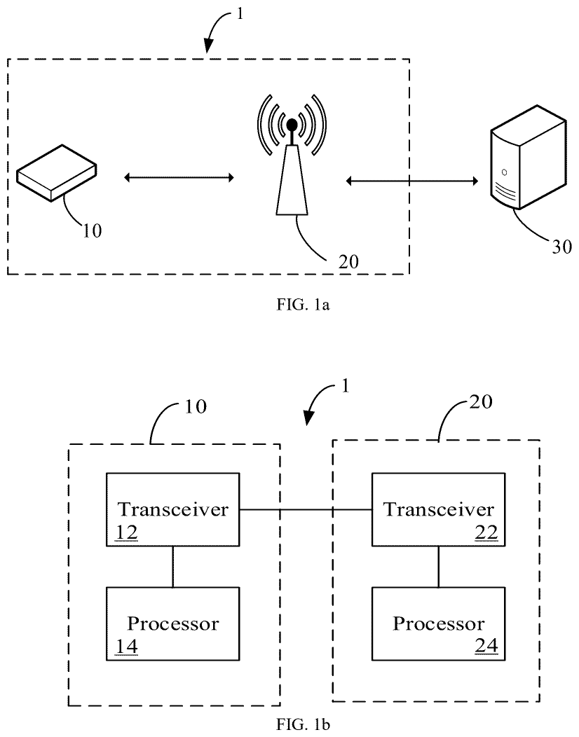

A schematic view and a functional block diagram of a communication controlling system 1 according to the present disclosure are shown in FIG. la and FIG. 1b respectively. The communication controlling system 1 includes a user equipment 10 and a base station (which is a network control node such as a gNB) 20. The user equipment 10 and the base station 20 may communicate with each other either wirelessly or in a wired way. The base station 20 and a next generation core network 30 may also communicate with each other either wirelessly or in a wired way. When the communication controlling system 1 complies with the New Radio (NR) standard of the 3rd Generation Partnership Project (3GPP), the next generation core network (5GCN) 30 is a backend serving network system and may include an Access and Mobility Management Function (AMF), User Plane Function (UPF), and a Session Management Function (SMF). The user equipment 10 may be a NES-capable UE, which support network energy saving (NES) capability, but the present disclosure is not limited to this. The user equipment 10 includes a transceiver 12 and a processor 14, which are electrically connected with each other. The base station 20 includes a transceiver 22 and a processor 24, which are electrically connected with each other. The transceiver 12 of the user equipment 10 is configured to transmit a signal to the base station 20 (and receive a signal from the base station 20) and the processor 24 of the base station 20 processes the signal, the transceiver 22 of the base station 20 is configured to transmit a signal to the user equipment 10 (and receive a signal from the user equipment 10) and the processor 14 of the user equipment 10 processes the signal. In this way, the user equipment 10 communicates with the base station 20 each other.

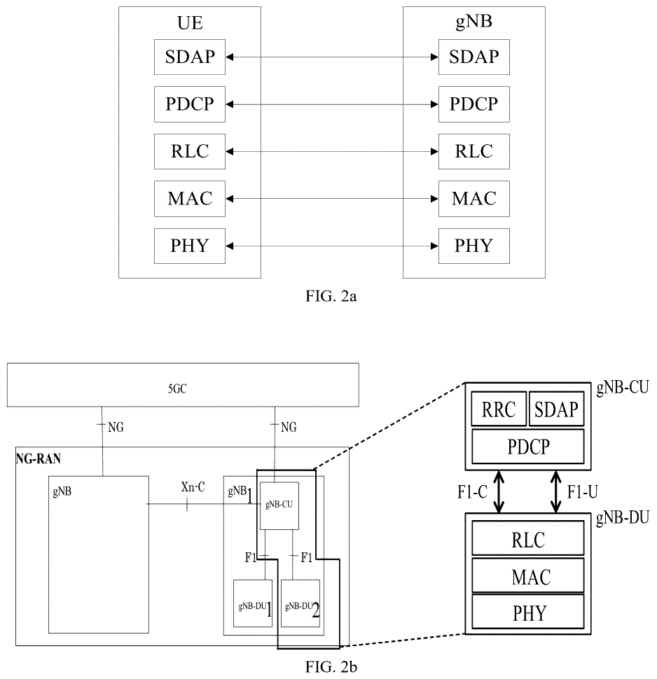

The radio protocol architecture within the base station (gNB) and UE is shown in FIG. 2a, which includes Service Data Adaptation Protocol (SDAP), Packet Data Convergence Protocol (PDCP), Radio Link Control (RLC), Medium Access Control (MAC). In RAN functional split, the gNB further includes a centralized unit (CU) and a plurality of distributed unit (DUs) as shown in FIG. 2b. The protocol stack of CU includes an RRC layer, a SDAP layer, and a PDCP layer, while the protocol stack of DU includes an RLC layer, a MAC layer, and a PHY layer. The F1 interface between the CU and DU is established between the PDCP layer of the protocol stack and the RLC layer of the protocol stack.

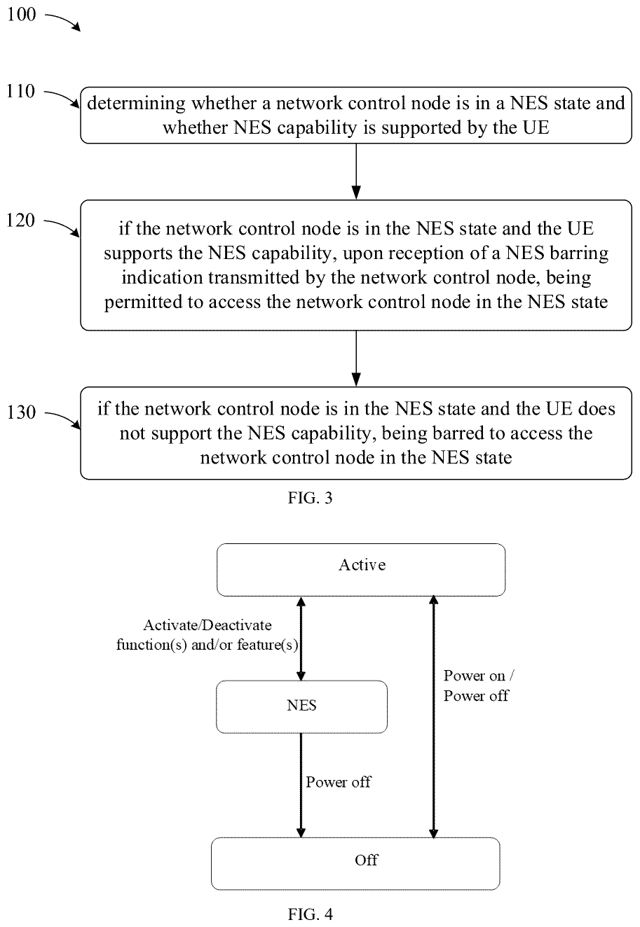

FIG. 3 is a flowchart of a network energy saving (NES) method 100 according to some embodiments of the present disclosure. The method 100 is performed by a user equipment (UE) and includes the following steps. In step 110, the UE determining whether a network control node (e.g., a base station, gNB) is in a NES state and whether NES capability is supported by the UE. If the network control node is in the NES state, it means some of function components and/or radio access features of the network control node are reduced/deactivated so as to greatly save energy consumption. The UE may determine the network control node is in the NES state, upon reception of a connected-discontinuous reception (C-DRX) or discontinuous transmission (DTX) configuration or a frequency/BWP/carrier switching indication from the network control node. The UE is a NES-capable UE if the UE supports the NES capability; and the UE is a non-NES-capable UE if the UE does not support the NES capability. The UE can determine whether it is a NES-capable UE by itself by self-testing or by an indication of a self-contained parameter, but is not limited thereto. In Step 120, if the network control node is in the NES state and the UE supports the NES capability, upon reception of a NES barring indication transmitted by the network control node, the UE is permitted to access the network control node in the NES state. In Step 130, if the network control node is in the NES state and the UE does not support the NES capability, the UE is barred to access the network control node in the NES state. That is, only a NES-capable UE can access to the network control node in the NES state. A non-NES-capable UE would be barred the accessing to the network control node in the NES state. By this NES barring indication, the network control node can serve only the NES-capable UEs very well and exclude the non-NES-capable UEs from attempting to access the network control node in the NES state.

With the proposed method 100 illustrated above, the network control node can operate in the NES state, thereby lowering power consumption for the network. Only the NES-capable UEs receive the NES barring indication are permitted to access the network control node in the NES state. This can exclude the non-NES-capable UEs in a simplified but useful manner.

In some embodiments, the network control node is determined to be in the NES state upon reception of a connected-discontinuous reception (C-DRX) or discontinuous transmission (DTX) configuration or a frequency/BWP/carrier switching indication by the UE.

In some embodiments, the UE is a NES-capable UE, which supports the NES capability.

In some embodiments, the method further comprises:
being configured with a separate preamble group for the NES state; and
performing a random access procedure by using a preamble in the separate preamble group to access the network control node in the NES state.

In some embodiments, the NES barring indication is used to indicate access control on a NES radio resource, which is a type of radio resource which is used for network energy saving.

In some embodiments, the method further comprises:
being allocated the NES radio resource on a NES Bandwidth Part (BWP) for performing data transmission on the NES radio resource.

In some embodiments, the data is transmitted or received on the NES radio resource for at least one specific UE group.

In some embodiments, the method further comprises:
receiving a NES configuration for configuring the NES radio resource.

In some embodiments, the NES configuration is provided to the UE by system information or RRC signaling.

In some embodiments, separate time slots are allocated for both uplink and downlink according to the NES configuration.

In some embodiments, separate frequency ranges of bands are used for uplink and downlink according to the NES configuration.

In some embodiments, a NES guard band is allocated between the separate frequency ranges of bands. In some embodiments, a common NES band/BWP is available for the UE, and the common NES band/BWP is shared by multiple network control nodes.

In some embodiments, for the common NES band/BWP shared by the multiple network control nodes, a NES guard time is used to differentiate transmission and reception from different network control nodes or UEs.

In some embodiments, the NES radio resource is a common DL/UL NES radio resource shared by Master Cell Group (MCG)/ Secondary Cell Group (SCG) serving the UE.

In some embodiments, DL-only transmission or UL-only transmission is allowed on the NES radio resource in the NES state.

In some embodiments, the method further comprises: monitoring Physical Downlink Control Channel (PDCCH) scrambled by NES-RNTI (Radio Network Temporary Identifier) during the NES state of the network control node.

In some embodiments, an activation request is supported by the UE to dynamically require on/off duration to the network control node in a time domain.

In some embodiments, the UE uses a cell-specific primary cell provided by the network control node in the NES state.

In some embodiments, a C-DRX/DTX configuration is shared between the UE and the network control node.

In some embodiments, the method further comprises:
monitoring paging occasions aligned with on durations of the network control node configured in the C-DRX/DTX configuration.

In some embodiments, the method further comprises:
monitoring on/off duration configured in the C-DRX/DTX configuration with an aid of a NES timer.

In some embodiments, the method further comprises:
switching from on duration to off duration upon expiry of a NES timer, wherein the on/off duration is configured in the C-DRX/DTX configuration.

In some embodiments, the method further comprises:
keeping state alignment between the UE and the network control node with an aid of a NES timer.

In some embodiments, the method further comprises:
monitoring activity of the NES radio resource with an aid of a NES timer.

In some embodiments, the method further comprises:
switching from a first BWP on which the NES radio resource resides to a second BWP different from the first BWP for performing radio access upon expiry of a NES timer.

In some embodiments, the method further comprises:
transmitting a wake-up request to the network control node upon expiry of a NES timer for keeping connected with the network control node without BWP switching.

In some embodiments, the UE gets synchronization, system information and paging from a primary cell (PCell).

In some embodiments, the UE expects Synchronization Signal Block (SSB)-less or System Information Block (SIB)-less or paging-less on a secondary cell (SCell) is enabled on a secondary cell (SCell) of the network control node in the NES state.

Analogous to the NES method 100 described above, the present disclosure further provides a network energy saving method performed by a network control node. The method by the network control node may include the following steps: transmitting a NES barring indication to a user equipment (UE) to permit the UE to access the network control node in a NES state if the UE is a NES-capable UE which supports NES capability; and baring the UE to access the network control node in the NES state if the UE is a non-NES-capable UE which does not support the NES capability. Further details are referred to the method 100 described above and are not repeated herein. With the method by the network control node, the network control node can operate in the NES state, thereby lowering power consumption for the network. Only the NES-capable UEs receive the NES barring indication are permitted to access the network control node in the NES state. This can exclude the non-NES-capable UEs in a simplified but useful manner.

In some embodiments, the method further comprises:
configuring a separate preamble group for the NES state for the NES-capable UE to perform a random access procedure by using a preamble in the separate preamble group to access the network control node in the NES state.

In some embodiments, the NES barring indication is used to indicate access control on a NES radio resource, which is a type of radio resource which is used for network energy saving.

In some embodiments, the method further comprises:
allocating the NES radio resource on a NES Bandwidth Part (BWP) for the NES-capable UE to perform data transmission on the NES radio resource.

In some embodiments, the data is transmitted or received on the NES radio resource for at least one specific UE group.

In some embodiments, the method further comprises:
transmitting a NES configuration to the NES-capable UE for configuring the NES radio resource.

In some embodiments, the NES configuration is provided to the NES-capable UE by system information or RRC signaling.

In some embodiments, separate time slots are allocated for both uplink and downlink according to the NES configuration.

In some embodiments, separate frequency ranges of bands are used for uplink and downlink according to the NES configuration.

In some embodiments, a NES guard band is allocated between the separate frequency ranges of bands.

In some embodiments, a common NES band/BWP is available for the NES-capable UE, and the common NES band/BWP is shared by multiple network control nodes.

In some embodiments, for the common NES band/BWP shared by the multiple network control nodes, a NES guard time is used to differentiate transmission and reception from different network control nodes or NES-capable UEs.

In some embodiments, the NES radio resource is a common DL/UL NES radio resource shared by Master Cell Group (MCG)/ Secondary Cell Group (SCG) serving the NES-capable UE.

In some embodiments, DL-only transmission or UL-only transmission is allowed on the NES radio resource in the NES state.

In some embodiments, the method further comprises:
receiving an activation request from the NES-capable UE to request the network control node to dynamically require on/off duration in a time domain.

In some embodiments, the network control node provides a cell-specific primary cell for the NES-capable UE.

In some embodiments, the method further comprises:
determining the NES barring indication based on service requirement.

In some embodiments, the method further comprises:
determining the NES barring indication based on NES coordination.

In some embodiments, the method further comprises:
paging only the UE which is in a NES paging area within a Core Network (CN)/ Radio Access Network (RAN) notification area.

In some embodiments, a C-DRX/DTX configuration is shared between the NES-capable UE and the network control node.

In some embodiments, the method further comprises:
switching from on duration to off duration upon expiry of a NES timer, wherein the on/off duration is configured in the C-DRX/DTX configuration.

In some embodiments, the method further comprises:
falling back to an active state upon expiry of a NES timer.

In some embodiments, the method further comprises:
keeping state alignment between the NES-capable UE and the network control node with an aid of a NES timer.

In some embodiments, the method further comprises:
monitoring activity of the NES radio resource with an aid of a NES timer.

In some embodiments, the method further comprises:
indicating the NES-capable UE to switch from a first BWP on which the NES radio resource resides to a second BWP different from the first BWP for performing radio access upon expiry of a NES timer.

In some embodiments, the method further comprises:
in response to a wake-up request from the NES-capable UE, transiting to on duration or an active state.

In some embodiments, the method further comprises:
offloading the NES-capable UE to a neighboring cell for keeping in the NES state.

In some embodiments, the method further comprises:
deactivating some of operational bandwidths or carrier components in consideration of cell loading.

In some embodiments, the carrier components are contiguous component carriers or non-contiguous component carriers for intra-band aggregation, or carrier components for inter-band aggregation.

In some embodiments, activation or deactivation of the carrier components is done via a signaling including a bitmap where each bit indicates a status of each of the carrier components or each combination of the carrier components should be activated or deactivated.

In some embodiments, primary cell (PCell) switching is supported in the network control node in the NES state.

In some embodiments, the method further comprises:
deactivating a secondary cell (SCell) in consideration of cell loading.

In some embodiments, the method further comprises:
deactivating some of channels/signals of a SCell in consideration of cell loading.

In some embodiments, Synchronization Signal Block (SSB)-less or System Information Block (SIB)-less or paging-less is enabled on SCell of the network control node in the NES state.

In some embodiments, the method further comprises:
deactivating some of operating distributed units (DUs) or user-plane (UP) nodes in consideration of cell loading.

In some embodiments, the method further comprises:
deactivating some of operational logical nodes in consideration of cell loading.

In some embodiments, the method further comprises:
determining whether to turn on or turn off corresponding user-plane (UP) nodes based on UE assistance information.

Further details of the invention are described as follows.

FIG. 4 shows an overview of gNB state transitions in NR. A gNB is either in Active state or in Network Energy Saving (NES) state when the power of gNB has been turned on. In NES state, some of function components and/or radio access features can be reduced/deactivated so as to greatly save energy consumption of gNB. From UE's perspective, upon the reception of NES barring indication, some UEs (e.g., non-NES-capable UEs) may not access to the gNB while some other UEs (e.g., NES-capable UEs) would be permitted to access the gNB in NES state. Multiple power levels are supported with the associated transition time/energy. For an example, upon the reception of NES barring indication, the NES-capable UE is permitted to access the gNB in the NES state while the non-NES-capable UE is barred to access the gNB in the NES state. For another example, the NES-capable UE met the criteria of NES access (e.g., power level) is permitted to access the gNB in the NES state while the NES-capable UE but not met the criteria of NES access (e.g., power level) is barred to access the gNB in the NES state upon the reception of NES barring indication. In some cases, the network and UE can keep the UE AS context for radio access with lower power consumption in NES state. In addition, after the NES negotiation between core network and gNBs, the network and UE can share the C-DRX/DTX (connected-discontinuous reception/discontinuous transmission) configuration through RRC signaling, the dynamic radio resources in time/frequency domain granularity such as BWP/RB/subframe/slot/symbol deactivation is supported in NES state. The related C-DRX/DTX parameters are common and/or associated for each other. In some other cases, based on the service requirement, the NES state allows DL-only transmission (e.g., MBS) or UL-only reception (e.g., SDT) within a pre-configured time/frequency resource.

The following categorized techniques, but not limited to, can be joint adaptation in NES state.
Time domain techniques: reducing/adapting the common channel(s)/signal(s) (e.g., SSB, SIB1, other SIB, paging, PRACH, etc.) transmission duration if the cell loading is light. In some cases, for reducing signaling overhead, the partial common signal(s) (e.g., SSB, SIB1, other SIB, paging) transmission is supported. The impact to initial access procedure, cell (re)selection, handover, synchronization and measurements performed by the RRC IDLE/RRC INACTIVE/RRC CONNECTED UE can be recovered by the NES coordination over network interfaces. The NES coordination can perform information exchange between core network (e.g., AMF, UPF, SMF) and radio network (e.g., gNBs) to avoid service loss. Furthermore, reducing the transmission/reception of periodic/semi-persistent channel(s)/signal(s) (e.g., reference signal(s), group-common/UE-specific PDCCH/PDSCH, group-common/UE-specific PUCCH/PUSCH etc.) can facilitate the network energy saving. The cell/BWP/RB/subframe/slot/symbol activation request is supported by the UE to dynamically require cell/BWP/RB/subframe/slot/symbol on/off duration. UE C-DRX/DTX (re)configuration/(de)activation is adapted in a NES grouping or cell-specific manner. The gNB DTX configuration is supported based on UE traffic/location/density. Some of UE assistant information (e.g., via on-demand SI request, tracking area updating, CSI reporting, etc.) including preferred C-DRX/DTX periodicity, preferred resource configuration is used to aid time domain NES adaptation. Upon the reception of C-DRX/DTX configuration (e.g., via system information, RRCReconfiguration, RRCRelease, Paging) from the network, the UE assumes the network is in NES state.
Frequency domain techniques: for operations within single carrier, including the transmission bandwidth adjustments of BWP/RB used by UEs for transmission and reception. Supporting dedicated NES BWP for network energy saving, and the associated BWP switching mechanism. A NES BWP switching indication is used to indicate the UE to switch to the NES BWP after an optional NES BWP switching timer expiry. The resource configuration of SPS PDSCH and CG PUSCH is adaptive on the NES BWP based on UE traffic/QoS requirement. For operations with multiple carriers, including enablement of SIB-less operation for some CC (e.g., secondary cell, non-anchor cell) in case of intra-band and inter-band CA. A NES grouping PCell/SCell switching signaling is used to cell activation/deactivation while the triggering condition is occurred. Leveraging the reduced common/SPS channel/signal transmission period in carrier aggregation operations. The NES coordination can perform information exchange between core network (e.g., AMF, UPF, SMF) and radio network (e.g., gNBs) to avoid radio access loss. Some of UE assistant information (e.g., via MSG1, scheduling request, uplink reference signal, etc.) including preferred frequency/BWP/carrier configuration is used to aid Frequency domain NES adaptation. Upon the reception of switching indication (e.g., via DCI, MAC CE) from the network, the UE assumes the network is in NES state.
Power domain techniques: adapting the transmission power of gNB transceiver to improve PAPR and power efficiency. Multiple power levels/beams and PA power reduction are used with the associated transition time/energy based on UE traffic/location/density. Some of UE assistant information (e.g., via measurement reporting, CSI reporting, SRS transmission, etc.) including preferred beam configuration is used to aid power domain NES adaptation. The NES coordination can perform information exchange between core network (e.g., AMF, UPF, SMF) and radio network (e.g., gNBs) to avoid coverage hole.
Spatial domain techniques: enabling dynamic spatial element adaptation, such as antenna element(s), antenna panel(s), logical antenna port(s), Transmission Resource Unit(s) (TXRU), Transmission Reception Point(s) (TRP) which is co-located or geographically separated from each other, but not limited to. The impact to UE operations from dynamic spatial elements adaptation, e.g., initial access, measurements, CSI feedback, PUSCH/PDSCH repetition, SRS transmission, beam management/beam failure recovery, cell (re)selection, etc. is supported. The NES coordination can perform information exchange between core network (e.g., AMF, UPF, SMF) and radio network (e.g., gNBs) to avoid coverage hole(s). Some of signaling transmissions (e.g., DCI, MAC CE, RRC signaling, F1 signaling, Xn signaling, backhaul signaling, etc.) is used to aid spatial domain NES adaptation.

To achieve NES efficiency with low signaling overhead and ensure backwards compatibility to legacy UE, some of pre-configured/configurable radio resource/period used in NES state are necessary. A NES BWP/RB/SSB/subframe/slot/symbol is a type of radio resource which is used for lower energy consumption. For example, but not limited to, a NES BWP is used to perform DL/UL data transmission. The network may configure a separate preamble group for NES state and then allocate NES RB/SSB/subframe/slot/symbol resources for transmitting/receiving data on the NES DL/UL BWP. The NES BWP would be an initial BWP or an active BWP. The UEs should monitor PDCCH scrambled by NES-RNTI in the provided common/UE-specific search space, including SearchSpaceZero, SearchSpaceSIB1, SearchSpaceOtherSystemInformation, ra-SearchSpace, pagingSearchSpace (e.g., Type0, 0A, 1, 2, etc.) during NES state of the network within the NES BWP.

The NES configuration (e.g., NES radio resource, NES barring indication, NES resource transmission pattern, NES resource transmission period (DTX-onDuration Timer), NES power level, NES spatial element, NES network identifier) is provided to the UEs within system information and/or RRC signaling (e.g., RRCReconfiguration, RRCRelease, Paging). In general, the NES configuration can be coordinated by the NES coordination or be distributed between the gNBs.

Based on the NES configuration, there is a NES timer (re)started or stopped for monitoring the activity of UL/DL NES RB/SSB/subframe/slot/symbol and/or on/off duration during NES state. In some cases, the network should fallback to Active state on the initial BWP when the NES timer expires in NES state. In some cases, the network should switch from on duration to off duration upon the expiry of NES timer which is based on the NES C-DRX/DTX configuration in NES state. In some cases, the UE may switch to the initial/NES BWP for performing radio access upon the NES timer expiry.

In some cases, for keeping the connection without BWP switching, the UE may transmit a wake-up request on NES BWP to the network during the stopped NES timer (e.g., emergency call during the running of DTX-offDuration Timer). The network can enter in on duration on the NES BWP or Active state to reconfigure the NES configuration if necessary.

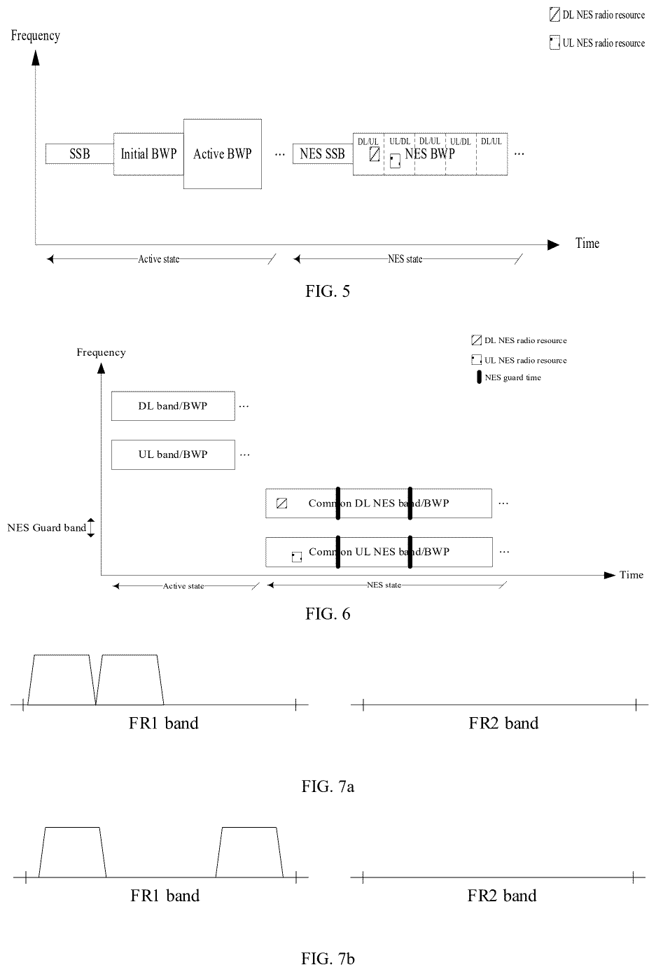

FIG. 5 shows a network control node (e.g., gNB) and terminal devices (e.g., UE(s)) operated in NES state of gNB for Time Division Duplex (TDD) system according to a first embodiment of the present application.

In NES TDD system, the separate time slots will be allocated for both uplink and downlink (e.g., Self-Contained scheduling) depending on NES configuration. In FIG. 5, the gNB can initially operate in Active state when power is on, then operate in NES state while the NES triggering condition (e.g., light cell loading, low UE traffic) is triggered. The NES SSB and NES BWP are available for the UE(s) when gNB enters NES state. Considering NES use cases, the NES BWP would be an initial BWP or an active BWP. The NES SSB is partial SSB with longer period of SSB occasions. The SIB1 or other system information provides the NES configuration for all serving UE(s) in the cell and the RRC signaling (e.g., RRCReconfiguration, RRCRelease, Paging) may also provide the NES (re)configuration for the dedicated UEs.

A NES barring indication is used to indicate the access control on NES radio resource (e.g., RB/SSB/subframe/slot/symbol). The NES barring indication is used to allow at least one-UE group to access the limited NES service (e.g., delay-tolerant service, special service). In other words, some of UEs may be barred to access the NES radio resource (e.g., NES RB/SSB/subframe/slot/symbol) upon the reception of NES barring indication. For an example, upon the reception of NES barring indication, the NES-capable UE is permitted to access the gNB in the NES state while the non-NES-capable UE is barred to access the gNB in the NES state. For another example, the NES-capable UE met the criteria of NES access (e.g., power level) is permitted to access the gNB in the NES state while the NES-capable UE but not met the criteria of NES access (e.g., power level) is barred to access the gNB in the NES state upon the reception of NES barring indication. Under such operations, the NES barring indication may be determined by the gNB based on service requirement or determined by a NES coordinator after performing the NES coordination. The NES coordination can exchange information between core network and radio network to avoid service loss.

Based on the service requirement, the network may even configure DL-only transmission (e.g., MBS) or UL-only reception (e.g., SDT) resource on the NES radio resource. The DL/UL data is transmitted on the NES radio resource for at least one specific UE group via NES power/spatial domain techniques if necessary.

In some cases, the gNB(s) and UE(s) can share the C-DRX/DTX configuration so that the UE(s) can monitor the paging occasions aligned with gNB's On Durations. The C-DRX/DTX parameters are common and associated with each other. In terms of paging operation, the UE can be paged by all gNBs in the same CN/RAN notification area. The gNB(s) operate in NES state can page only the UE(s) which is in the NES paging area within a CN/RAN notification area. The NES paging area compromised by core network with neighboring cells is a smaller serving coverage than that operated in Active state of gNB so as to reduce energy consumption. Therefore, the gNB(s) in NES state can transmit paging message on NES radio resources within longer periodicity and NES power/spatial domain adaptation if necessary.

Upon the transmission/reception of NES configuration in system information and/or RRC signaling (e.g., RRCReconfiguration, RRCRelease, Paging), a NES timer can be started or restarted for keeping state alignment between network and UE(s). In some cases, the On-duration and related C-DRX/DTX parameters are associated with each other. When a UE camps on a NES cell, a wake-up request/cell reselection may be initiated during the stopped NES timer. In response to the wake-up request, the network may transit to on duration or Active state to ensure the QoS. In some cases (e.g., there is only one UE within the serving cell), the network may offload (i.e., network-initiated cell reselection) the UE to the neighboring cell for keeping in NES state.

FIG. 6 shows a network control node (e.g., gNB) and terminal devices (e.g., UE(s)) operated in NES state of gNB for Frequency Division Duplex (FDD) system according to a second embodiment of the present application.

In NES FDD system, separate frequency range of the bands will be used for uplink and downlink depending on NES configuration. Using a NES guard band can facilitate reducing interference from each band upon transmission and reception simultaneously without more power consumption. Each NES gNB can operate the frequency domain NES adaptation as described above on the associated DL/UL band/BWP respectively and hence are not repeated. Alternatively, each NES gNB operated with inter/intra network operator may share a common DL/UL NES band/BWP in light cell loading. In some cases, a group-common DL/UL NES band/BWP can be shared by gNBs in the same CN/RAN notification area (not shown). In FIG. 6, the gNB can initially operate in Active state when power is on, then operate in NES state while the NES triggering condition (e.g., light cell loading, low UE traffic) is triggered. The common DL/UL NES band/BWP are available for the UE(s) when gNB enters in NES state. Those gNBs share the same common DL/UL NES band/BWP can use a NES guard time to differentiate the transmission and reception from the serving gNB/the corresponding UE. The SIBI or other system information provides the NES configuration for all serving UE(s) in the cell and the RRC signaling (e.g., RRCReconfiguration, RRCRelease, Paging) may also provide the NES (re)configuration for the dedicated UEs.

A NES barring indication is used to indicate the access control on NES radio resource (e.g., RB/SSB/subframe/slot/symbol). The NES barring indication is used to allow at least one UE group to access the limited NES service (e.g., delay-tolerant service, special service). In other words, some of UEs may be barred to access the NES radio resource (e.g., NES RB/SSB/subframe/slot/symbol) upon the reception of NES barring indication. For an example, upon the reception of NES barring indication, the NES-capable UE is permitted to access the gNB in the NES state while the non-NES-capable UE is barred to access the gNB in the NES state. For another example, the NES-capable UE met the criteria of NES access (e.g., power level) is permitted to access the gNB in the NES state while the NES-capable UE but not met the criteria of NES access (e.g., power level) is barred to access the gNB in the NES state upon the reception of NES barring indication. Under such operation, the NES barring indication and NES guard time may be determined by a NES coordinator based on service requirement after performing the NES coordination. The NES coordination can exchange information between core network and radio network to avoid radio access loss.

Based on the service requirement, the network may even configure DL-only transmission (e.g., MBS) or UL-only reception (e.g., SDT) resource on the DL/UL band/BWP or common DL/UL NES band/BWP. The DL/UL data is transmitted on the NES radio resource for at least one specific UE group via NES power/spatial domain techniques if necessary.

In some cases, the gNB(s) and UE(s) can share the C-DRX/DTX configuration so that the UE(s) can monitor the paging occasions on common DL NES band/BWP. In terms of paging operation, the UE can be paged by all gNBs in the same CN/RAN notification area. The gNB(s) operates in NES state can page only the UE(s) which is in the NES paging area within a CN/RAN notification area. The NES paging area compromised by core network with neighboring cells is a smaller serving coverage than that operated in Active state of gNB so as to reduce energy consumption. Therefore, the gNB(s) in NES state can transmit paging message on NES radio resources within longer periodicity and NES power/spatial domain adaptation if necessary. In some cases, those gNBs (i.e., some gNBs are in Active state and the other are in NES state) in the same CN/RAN notification area can operate in the same group-common DL NES band/BWP so that the smaller NES paging area can be cooperative with the other gNBs in Active state.

Upon the transmission/reception of NES configuration, a NES timer can be started or restarted for keeping state alignment between network and UE(s). When a UE camps on a NES cell, a wake-up request/cell reselection may be initiated during the stopped NES timer. In response to the wake-up request, the network may transit to on duration or Active state to ensure the QoS. In some cases (e.g., there is only one UE within the serving cell), the network may initiate the cell reselection for the UE to the neighboring cell for maintaining gNB in NES state. With such common DL/UL NES band/BWP operation, it can facilitate energy efficiency for the network and UEs without resource utilization degradation.

FIG. 7 shows a network control node (e.g., gNB) and terminal devices (e.g., UE(s)) operated in NES state of gNB for multi-carrier operation (i.e., carrier aggregation, CA) according to a third embodiment of the present application.

Carrier aggregation in NR system supports up to 16 contiguous and non-contiguous carrier components (CCs) with different numerologies in FR1 band and FR2 band. FIG. 7 (a)-(c) show three different CA scenarios, that are, intra-band aggregation with contiguous component carriers, intra-band aggregation with non-contiguous component carriers, and inter-band aggregation respectively. In addition to TDD/FDD operation, reducing operating bandwidth/carrier component at gNB can also facilitate the network energy saving. The network can deactivate some of the operational bandwidths/carrier components based on the cell loading and/or traffic pattern. A BWP adaptation/switching from active BWP to initial/default BWP is required when the cell loading is light.

In NES CA operation, the primary cell configuration should be changed from device-specific to cell-specific or group-specific. It means that the primary cell (PCell) which the devices within the gNB initially connect to may have the same anchor carrier (e.g., anchor cell). The secondary cell (SCell) can be deactivated when the cell loading is light. For intra-band/inter-band CA, reducing/adapting common channels/signals for SCell is support. The UE can get synchronization, system information and/or paging from PCell upon the enablement of SSB-less/SIB-less/paging-less on SCell. The transmission/reception SSB/SIB/paging on PCell is applied to the NES adaptation techniques as described above and hence are not repeated herein.

To enhance the network energy saving, there is a need for the network to indicate the (re)configuration of NES primary carrier via broadcast or multicast signaling. A group configuration update signaling transmitted through common channel(s) (e.g., BCH, MCCH, PCH) is necessary. In some cases, the activation/deactivation of CC can be done via L1/L2 signaling (e.g., RRC, MAC CE, DCI) including a pre-configured bitmap where each bit indicates the status of each CC or CC combination should be activated/deactivated. The scheduling grants can be transmitted on either the same carrier as the corresponding data (i.e., self-scheduling) or on a different carrier with the corresponding data (i.e., cross-carrier scheduling). In general, the scheduling grants would be transmitted/received on the NES primary carrier while the corresponding data may be transmitted/received either on NES primary carrier or on the indicated NES secondary carrier based on cell loading and/or traffic pattern regardless of the C-DRX/DTX. Regarding feedback transmission (e.g., HARQ), different PUCCH groups where feedback associated with different UE group is transmitted in the uplink of the NES primary carrier or primary secondary carrier (PSCell) on timing/frequency domain to differentiation.

For keeping synchronization between network and UE(s), a NES timer can be started or restarted upon the transmission/reception of NES multi-carrier configuration. When a UE is missing the alignment with NES primary carrier, a wake-up request/cell reconfiguration may be initiated during the stopped NES timer (e.g., upon the expiry of NES timer). In response to the wake-up request/cell reconfiguration, the network may transit to on duration or Active state to reconfigure the NES primary carrier configuration via broadcast/multicast/unicast manner.

When the gNB would like to change the NES primary carrier configuration (e.g., PCell switching) for all or more UEs within the serving cell, it may update the NES primary carrier configuration via broadcast or multicast signalling. If the update is only done for the UE(s), the gNB may transmit unicast signaling (e.g., RRC signaling) without state transition. In some cases, the change of NES primary carrier may be initiated by gNB when the triggering condition (e.g., a specific UE group camping on) of dynamic NES primary carrier switching is met.

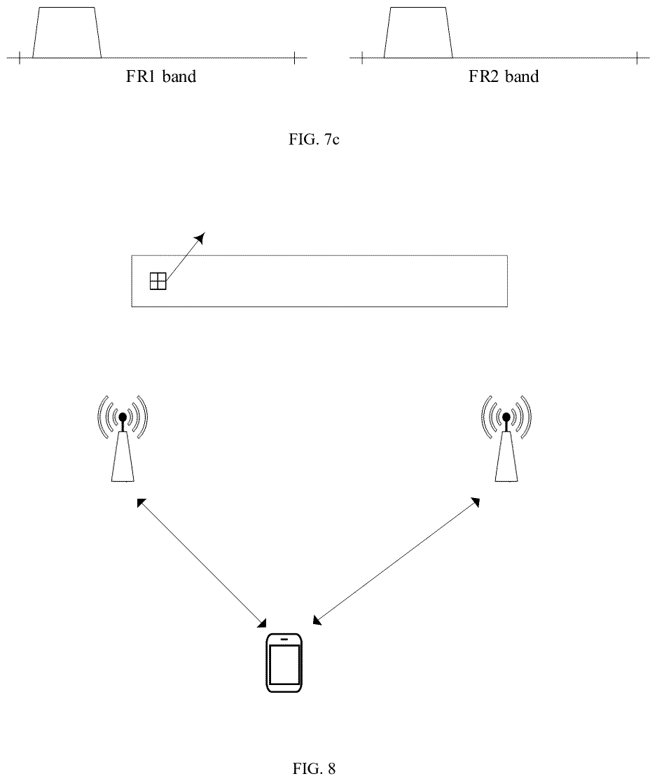

FIG. 8 shows a network control node (e.g., gNB, MCG, SCG) and terminal devices (e.g., UE(s)) operated in NES state of the network for multi-connection operation (i.e., dual connectivity, multi-connectivity) according to a fourth embodiment of the present application.

Multi-connectivity in NR system supports a UE connected to more than one cell from multiple sites simultaneously. In dual connectivity, a UE is camping on two cells or two cell groups, that is Master Cell Group (MCG) and Secondary Cell Group (SCG) to handle the case of carrier aggregation in which there are multiple sites. It means that the MCG/SCG can be operated by different gNBs. A tighter coordination between the MCG and SCG is supported for NES. A NES coordination can exchange information between core network and radio network to avoid connection link failure. This NES coordination may focus on interference avoidance as in the case where the DL duplication data may be transmitted by MCG and SCG simultaneously.

In multi-connection scenario, a common DL NES radio resource can be shared by MCG/SCG serving the same UE(s) when DL-only transmission is configured. Given that, each NES MCG/SCG can operate the NES adaptation techniques as described above on the associated common NES radio resource respectively and hence are not repeated. In other words, each NES MCG/SCG operated with inter/intra network operator may share a common DL/UL NES radio resource in light cell loading. For UL, if the scheduling is coordinated from the MCG/SCG, the UL duplication data can be transmitted on the common UL NES radio resource individually and then take advantage of the duplicated reception to significantly improve the link performance.

Upon the transmission/reception of NES multi-connection configuration, a NES timer can be started or restarted for keeping state alignment between MCG/SCG and UE(s). A wake-up request/cell reselection may be initiated during the stopped NES timer. In response to the wake-up request, the MCG/SCG may transit to on duration or Active state to reconfigure the multi-connection if necessary. In some cases (e.g., there is only one UE served by the same MCG/SCG), the MCG or SCG may initiate the cell redirect for the UE to the neighboring cell for keeping in NES state. With such common NES radio resource operation in multi-connection scenario, it can facilitate spectral and energy efficiency for the network.

FIG. 2b shows a network control node (e.g., gNB) and terminal devices (e.g., UE(s)) operated in NES state of the network for RAN functional split operation (i.e., PDCP-RLC split) according to a fifth embodiment of the present application.

In NR, there is a flexible architecture for the 5G RAN, where the base station (i.e., gNB) is split into two logical nodes, that is, centralized unit (gNB-CU) and distributed unit (gNB-DU) to allow scalable cost-effective network deployments (e.g., Cloud RAN (C-RAN) deployment). Each gNB may comprise a gNB-CU and a plurality of gNB-DUs as shown in FIG. 2b. The protocol stack of gNB-CU comprises an RRC layer, a SDAP layer, and a PDCP layer, while the protocol stack of gNB-DU comprises an RLC layer, a MAC layer, and a PHY layer. The Fl interface between the gNB-CU and gNB-DU is established between the PDCP layer of the protocol stack and the RLC layer of the protocol stack. In addition to the functional split between gNB-CU and gNB-DU, the functional split between Control plane and User plane is also supported within a gNB by establishing El interface (not shown). A logical node that terminates the Control plane of gNB is called gNB-CP, and a logical node that terminates the User plane of the gNB is called gNB-UP.

For network energy saving, reducing the number of operating gNB-DU or gNB-UP node(s) is helpful. The network can deactivate some of the operational logical nodes based on the provided service information (e.g., service priority, delay-tolerant service, data rate, data volume, service type, time-critical service) and traffic loading. Some of UE assistance information (e.g., preferred SSB configuration, buffer status report, etc.) is used to aid the network performing the NES adaptation techniques as described above and hence are not repeated.

For an extreme case, if the data transmission/reception is not on-going within the gNB's coverage, the gNB may provide only the necessary control signaling (e.g., SSB) via gNB-CP associated nodes for saving energy. In other words, the gNB can determine whether to turn on/off gNB-UP corresponding nodes based on some UE assistance information (e.g., the absence of semi-static UL transmissions, MDT).

Upon the transmission/reception of NES configuration, a NES timer can be started or restarted for keeping state alignment between gNB and UE(s). A wake-up request/cell reselection may be initiated during the stopped NES timer. In response to the wake-up request, the gNB may transit to on duration or Active state to activate the deactivated logical node(s) if necessary. If there is no response to the wake-up request, the UE performs the cell reselection to retrieve the service.

In some cases (e.g., emergency service), some of assistance information from UE/core network (e.g., emergency indication, emergency call, MLB, etc.) is used to inform the gNB to enter the Active state to activate the deactivated logical node(s). The associated gNB-CU/gNB-DU FIAP identifier and parameters, gNB-CP/gNB-UP ElAP identifier and parameters during NES (re)configuration would be used. The RRC message used in this embodiment for NES (re)configuration is encapsulated in the FIAP/E1AP message(s) (e.g., UE Context Modification, DL/UL RRC Message Transfer, etc.). With such flexible logical node(s) activation/deactivation of gNB, it can facilitate cost and energy efficiency for the network.

Commercial interests for some embodiments are as follows. 1. solving issues in the prior art 2. lowering power consumption for the network 3. achieving better resource efficiency for the network 4. achieving higher connection flexibility between UE and network 5. lowering signaling overhead for state transition 6. achieving service continuity due to mobility 7. providing a good communication performance. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR unlicensed band communications. Some embodiments of the present disclosure propose technical mechanisms.

The embodiment of the present application further provides a user equipment includes a memory and a processor coupled to the memory, the processor configured to call and run program instructions stored in a memory, to execute the afore-described cell reselection method. The details on this method are referred to above content and are not repeated herein.

The embodiment of the present application further provides a network control node (e.g., a base station) includes a memory and a processor coupled to the memory, the processor configured to call and run program instructions stored in a memory, to execute the afore-described method. The details on this method are referred to above content and are not repeated herein.

The embodiment of the present application further provides a computer readable storage medium for storing a computer program. The computer readable storage medium enables a computer to execute corresponding processes implemented by the UE/BS in each of the methods of the embodiment of the present disclosure. For brevity, details will not be described herein again.

The embodiment of the present application further provides a computer program product including computer program instructions. The computer program product enables a computer to execute corresponding processes implemented by the UE/BS in each of the methods of the embodiment of the present disclosure. For brevity, details will not be described herein again.

The embodiment of the present application further provides a computer program. The computer program enables a computer to execute corresponding processes implemented by the UE/BS in each of the methods of the embodiment of the present disclosure. For brevity, details will not be described herein again. Although not shown in detail any of the devices or apparatus that form part of the network may include at least a processor, a storage unit and a communications interface, wherein the processor unit, storage unit, and communications interface are configured to perform the method of any aspect of the present invention. Further options and choices are described below.

The signal processing functionality of the embodiments of the invention especially the gNB and the UE may be achieved using computing systems or architectures known to those who are skilled in the relevant art. Computing systems such as, a desktop, laptop or notebook computer, hand-held computing device (PDA, cell phone, palmtop, etc.) , mainframe, server, client, or any other type of special or general purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory, such as random access memory (RAM) or other dynamic memory, for storing information and instructions to be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface, such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms ‘computer program product’, ‘computer-readable medium’ and the like may be used generally to refer to tangible media such as, for example, a memory, storage device, or storage unit. These and other forms of computer-readable media may store one or more instructions for use by the processor including the computer system to cause the processor to perform specified operations. Such instructions, generally referred to as ‘computer program code’ (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

The non-transitory computer readable medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality. Thus, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices.

Thus, the elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1-73. (canceled)

74. A network energy saving (NES) method, performed by a user equipment (UE), the method comprising:
determining whether a network control node is in a NES state and whether NES capability is supported by the UE;
if the network control node is in the NES state and the UE supports the NES capability, upon reception of a NES barring indication transmitted by the network control node, being permitted to access the network control node in the NES state; and
if the network control node is in the NES state and the UE does not support the NES capability, being barred to access the network control node in the NES state.

75. The method of claim 74, wherein the network control node is determined to be in the NES state upon reception of a connected-discontinuous reception (C-DRX) or discontinuous transmission (DTX) configuration or a frequency/bandwidth part (BWP)/carrier switching indication by the UE.

76. The method of claim 74, wherein the UE is a NES-capable UE, which supports the NES capability.

77. The method of claim 76, wherein the NES barring indication is used to indicate access control on a NES radio resource, which is a type of radio resource which is used for network energy saving, and the method further comprises:
receiving a NES configuration for configuring the NES radio resource.

78. The method of claim 77, wherein separate time slots are allocated for both uplink and downlink according to the NES configuration.

79. The method of claim 77, wherein a common NES band/BWP is available for the UE, and the common NES band/BWP is shared by multiple network control nodes.

80. The method of claim 77, wherein the NES radio resource is a common DL/UL NES radio resource shared by Master Cell Group (MCG)/ Secondary Cell Group (SCG) serving the UE.

81. The method of claim 77, wherein DL-only transmission or UL-only transmission is allowed on the NES radio resource in the NES state.

82. The method of claim 76, further comprising:
monitoring Physical Downlink Control Channel (PDCCH) scrambled by NES-RNTI (Radio Network Temporary Identifier) during the NES state of the network control node.

83. The method of claim 76, wherein an activation request is supported by the UE to dynamically require on/off duration to the network control node in a time domain.

84. The method of claim 76, wherein the UE uses a cell-specific cell provided by the network control node in the NES state.

85. The method of claim 76, wherein a C-DRX/DTX configuration is shared between the UE and the network control node.

86. The method of claim 85, further comprising:
monitoring paging occasions aligned with on durations of the network control node configured in the C-DRX/DTX configuration.

87. The method of claim 85, further comprising:
monitoring on/off duration configured in the C-DRX/DTX configuration with an aid of a NES timer.

88. The method of claim 85, further comprising:
switching from on duration to off duration, wherein the on/off duration is configured in the C-DRX/DTX configuration.

89. The method of claim 77, further comprising:
monitoring activity of the NES radio resource with an aid of a NES timer.

90. The method of claim 76, wherein the UE expects Synchronization Signal Block (SSB)-less or System Information Block (SIB)-less or paging-less on a secondary cell (SCell) is enabled on a secondary cell (SCell) of the network control node in the NES state.

91. A network energy saving (NES) method, performed by a network control node, the method comprising:
transmitting a NES barring indication to a user equipment (UE) to permit the UE to access the network control node in a NES state if the UE is a NES-capable UE which supports NES capability; and
baring the UE to access the network control node in the NES state if the UE is a non-NES-capable UE which does not support the NES capability.

92. A user equipment (UE), comprising a memory and a processor coupled to the memory, the processor configured to call and run program instructions stored in a memory to execute the method of claim 74.

93. A network control node, comprising a memory and a processor coupled to the memory, the processor configured to call and run program instructions stored in a memory to execute the method of claim 91.
